(19) United States
(12) Patent Application Publication
(10) Pub. No.: US 2006/0028144 A1
(43) Pub. Date: Feb. 9, 2006

(54) Traveling wave tube with radioactive isotope charged particle source

(75) Inventor: Sebong Chun, Fullerton, CA (US)

Correspondence Address: ORIGIN LAW, 333 N INDIAN HILL BLVD, SUITE 208, CLAREMONT, CA, 91711, US

(73) Assignee: The Boeing Company, Chicago, IL (US)

(21) Appl. No.: 10/910,166

(22) Filed: Aug. 3, 2004

(51) Int. Cl. H01J 25/34

(52) U.S. Cl. 315/39.3; 315/3.5

(57) ABSTRACT

The invention discloses systems and methods for mediating electromagnetic interaction with an RF wave in a TWT. Embodiments of the present invention can be employed in high power amplifiers in satellite transponders or radar systems. Embodiments of the invention extract RF power directly from a radioactive isotope (e.g. ²³⁸Pu) by implementing a slow-wave structure in conjunction with the charged particles (e.g. alpha particles) from the isotope. In satellite applications, the invention can significantly reduce costs and mass by dramatically reducing the requirements of the supporting electrical power system.

### BACKGROUND OF THE INVENTION

1. Field of the Invention

The present invention relates to systems and methods for mediating an electromagnetic interaction with a radio frequency (RF) wave in a traveling wave tube (TWT). Particularly, this invention relates to systems and methods for amplifying an RF wave in a TWT that can be employed in a high power amplifier such as used in communications and radar systems.

2. Description of the Related Art

The traveling wave tube (TWT) is an amplifier (also referred to as a traveling wave tube amplifier (TWTA)) of microwave energy, operating through the interaction of an electron beam and an RF circuit known as a slow-wave structure (SWS). The term “slow-wave” comes from the fact that the RF wave velocity as it travels down the circuit is much less than that of light in free-space. As the electron beam travels down the slow-wave structure an energy exchange takes place between the particles and the RF circuit wave.

There are three basic components to a conventional TWT, the electron gun, the slow-wave circuit, and the collector. Any or all of these components can range from the very complicated to the simplistic in design depending upon the performance requirements.

The electron gun generates the electron beam is for the TWT. A cathode of the electron gun is the source of the electrons. The cathode is typically heated (e.g. above 750 degrees Celsius) and via thermionic emission and the application of a high voltage bias the electrons are released and accelerated. The cathode voltage may range in value from several thousands of volts to several hundreds of thousands depending upon the particular TWT.

The second major component of the TWT is the slow-wave structure. The slow-wave structure supports the RF signal over a particular band of frequencies, which can range as high as two or more octaves. There are numerous types of slow-wave structures, helical, coupled-cavity, ring-and-bar and many other types in this class. Typically, the frequency at which the device operates controls the geometry, or size of the structure. In addition, RF power handling performance is important when determining the type of SWS to use. The RF wave travels down the SWS and an interaction, or energy exchange, takes place between it and the electron beam resulting in amplification of the RF wave. One of the most important features of the SWS is that it must control the velocity of the RF wave such that it matches that of the beam.

After the energy has been extracted to the circuit the electron beam continues on to the collector which traps the spent electrons. There are various collector configurations used in TWTs. Some of these include single-stage grounded collectors and multiple stage collectors. Collector design is primarily focused on power efficiency and supply considerations.

In satellite applications, an essential component of a satellite transmitter is the high power amplifier (HPA). Satellite applications generally require an HPA delivering high gain and relatively low noise. Although transistorized power amplifiers are sometimes employed, TWTs are more commonly used as the HPA in satellite applications to meet the required performance characteristics. In addition, TWTs have also been employed in other applications, such as ground based communication and radar systems and other microwave equipment.

In a typical satellite, even with efficient TWTs, the HPAs may consume more than ninety percent of the available D.C. power. The electrical power system for a satellite includes solar arrays and batteries. These components are expensive and consume a significant portion of the mass budget. For example, the solar arrays and batteries for a typical communications satellite may cost ten million dollars and weigh a thousand pounds. Mass reduction is an omnipresent focus in any satellite design. Mass reduction aids in minimizing launch costs and/or allows for unused mass budget to be applied adding components which provide enhanced capabilities and improved performance.

In view of the foregoing, there is a need in the art for efficient systems and methods providing microwave energy amplification. Further, in satellite applications there is a need for more efficient high power amplifiers that can reduce the cost and weight of the supporting electrical power system. As detailed hereafter, these and other needs are met by the present invention.

### SUMMARY OF THE INVENTION

This invention presents a system and method for mediating electromagnetic interaction with an RF wave in a TWT. Embodiments of the present invention can be employed in high power amplifiers in satellite transponders or radar systems. Embodiments of the invention extract RF power directly from a radioactive isotope (e.g. ²³⁸Pu) by implementing a slow-wave structure in conjunction with the charged particles (e.g. alpha particles) from the isotope. In satellite applications, the invention can significantly reduce costs and mass by dramatically reducing the requirements of the supporting electrical power system.

Typical embodiments of the invention comprise a particle traveling wave tube employing a simple, long lasting radioactive isotope as a charged particle source. Embodiments of the invention may dramatically reduce or eliminate the need for a bulky high voltage power system and solar panels in a conventional satellite communication system. For example, alpha particles from ²³⁸Pu can be channeled through a cylindrical slow-wave structure and undergo a charge-wave interaction. The alpha particles gradually lose their kinetic energy via charge-wave interaction, thereby transferring their kinetic energy to the coupled wave. The alpha particles' large mass to charge ratio makes such and alpha TWT more linear than the conventional electron TWT. In addition, the high RF conversion efficiency of the alpha TWT makes such a device an attractive alternative for a radioisotope thermoelectric generator (RTG) used in deep space missions.

A typical embodiment of the invention includes a radioactive isotope producing charged particles and a slow-wave structure receiving a low power signal input. The slow-wave structure receives at least some of the charged particles and the received charged particles interact with the low power signal input to generate a high power signal output, the high power signal output corresponding to the low power signal input. In an exemplary embodiment, the radioactive isotope comprises a radioactive isotope such as ²³⁸Pu and the charged particles are alpha particles. In other embodiments, alpha particles may be emitted by other radioactive isotopes such as ²¹⁰Po, ²⁴² Cm, and ²⁴⁴ Cm. In other embodiments of the invention, the charged particles may comprise beta particles and the radioactive isotope is selected from the group consisting of ⁹⁰Sr, ¹⁰⁶Ru, ¹⁴⁴ Pm, ¹⁷⁰Tm, ¹³⁷Cs, and ¹⁴⁴Ce.

A typical method embodiment of the invention comprises the steps of emitting charged particles from a radioactive isotope, receiving at least some of the charged particles in a slow-wave structure, receiving a low power signal input to the slow-wave structure and generating a high power signal output from the interaction of the received charged particles and the low power signal input, the high power signal output corresponding to the low power signal input. The method and apparatus embodiments may be modified in a similar manner.

In further embodiments, a plurality of slow-wave structures for a given radioactive isotope, each receiving a portion of the charged particles. The received portion charged particles of each of the plurality of slow-wave structures interacts with a distinct low power signal input to generate a distinct high power signal output. The plurality of slow-wave structures may be disposed radially around the radioactive isotope, extending away from the radioactive isotope. In one exemplary embodiment, the plurality of slow-wave structures comprises three pairs of slow-wave structures and each pair is substantially collinear on opposite sides of the radioactive isotope and the pairs are orthogonally arranged. In another exemplary embodiment, at least two of the plurality of slow-wave structures are connected in series operating on a common particle beam. At least one of the plurality of slow-wave structures connected in series operating on the common particle beam may produce substantially DC power.

Typical embodiments can employ a magnet disposed between the radioactive isotope and the slow-wave structure. The magnet focuses the charged particles into a beam passing through the slow-wave structure. The magnet may comprise a permanent magnet. In one embodiment, the magnet is substantially conical with an axial passage the charged particles to pass through.

In a typical embodiment, the low power signal input and the high power signal output are each coupled to the received charged particles through helical conductors, the received charged particles passing through the helical conductors. The helical conductors may be disposed such that the low power signal input is upstream of the flow of the charged particles relative to the high power signal output.

### BRIEF DESCRIPTION OF THE DRAWINGS

Referring now to the drawings in which like reference numbers represent corresponding parts throughout:

FIG. 1 illustrates a conventional traveling wave tube;

FIG. 2 illustrates an exemplary traveling wave tube employing a radioactive isotope charged particle source;

FIG. 3 illustrates a series of slow-wave structures implemented with a single radioactive particle source;

FIG. 4 illustrates multiple slow-wave structures implemented with a single radioactive particle source operating in parallel;

FIG. 5 is a flowchart of an exemplary method of amplifying an RF wave employing a radioactive isotope charged particle source;

FIG. 6 shows theoretical plots of a illustrating a performance comparison between a conventional traveling wave tube and an alpha traveling wave tube; and

FIG. 7 illustrates capturing alpha particles emitted from ²³⁸Pu.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

1. Conventional Traveling Wave Tube

Having been around more than a half century, the basic principle of the traveling wave tube (TWT) is well understood. Many variants and modifications have developed over the years to improve and alter performance characteristics, however, the fundamental operation remains unchanged.

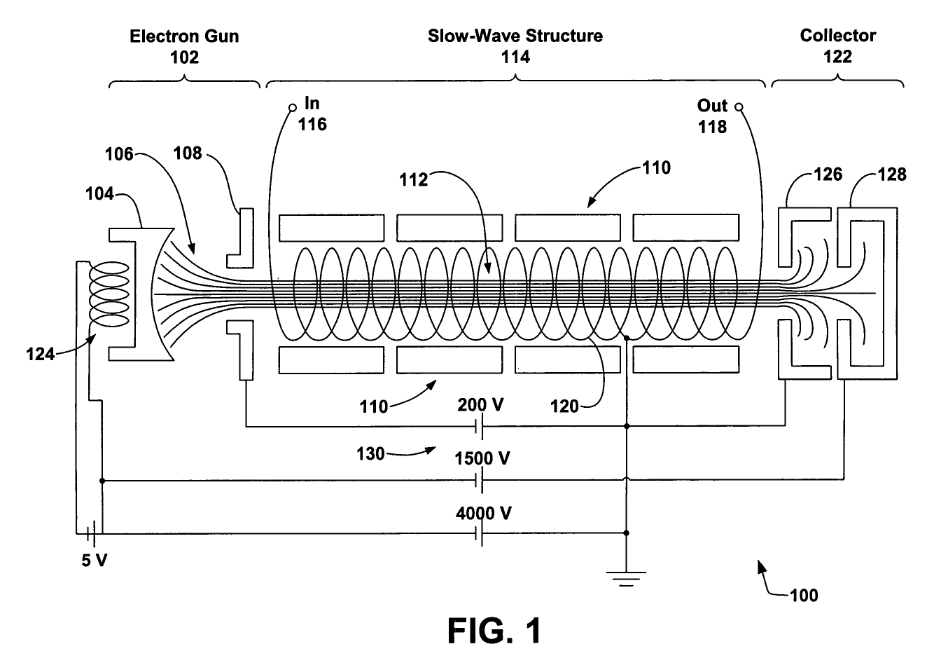

FIG. 1 illustrates a conventional TWT 100. The TWT 100 is cylindrical in shape, employing the electron gun 102 near one end generating a stream of electrons 106 that are expelled thermionically from a cathode 104 due to an electric heater 124. The electrons 106 are accelerated by an anode 108 down the axis of a slow-wave structure 114.

The TWT 100 includes one or more permanent magnets 110 which serve to maintain the electrons 106 in a beam 112 within the slow-wave structure 114. As the electron beam 112 passes through the slow-wave structure 114 it interacts with a electrical RF signal applied to the input 116 to produce a corresponding amplified RF signal at the output 118.

The slow-wave structure 114 includes one or more helical conductors 120. The conductors 120 receive the low power RF signal at the input 116 and deliver a high power RF signal at the output 118 (e.g. through directional couplers). As the low power RF signal is carried by the helical conductors, a corresponding electric field is produced around the coiled wire which interacts with the electron beam 112 passing through the center of the slow-wave structure 114.

The interaction results in energy being transferred from the electrons 106 of the electron beam 112 to the low power RF signal. Thus, the low power RF signal is amplified to a high power RF signal at the output 118. Although other electrical configurations are possible, in the exemplary slow-wave structure 114, the input 116 and output 118 share a common electrical ground as shown. The coil of the helical conductors 120 serves the important purpose of effectively “slowing” the speed of the RF signal it carries relative to the electron beam along the axis of the slow-wave structure 114. Although the RF signal moves along the conductor at an unchanged speed (approximately the speed of light), its speed is slowed along the axis of the slow-wave structure 114 because it must pass through each coil. Accordingly, the relative speed between the RF signal and the electron beam 112 can be varied with the number of coils and/or diameter of the coils of the helical conductors 120.

As the electron beam 112 exits the slow-wave structure 114, the electrons 106 are recovered in a collector 122. The collector 122 prevents the electrons 106 exiting the slow-wave structure 114 from flowing back towards the electron gun anode 108 and recovers the unused energy of the electrons. Various configurations for the collector 122 are possible. A multi-staged collector 122 employs a plurality of collector anodes 126, 128 each maintained at different voltage 130 with respect to the electron gun anode 108.

2. Traveling Wave Tube Employing a Radioactive Isotope Particle Source

In contrast to the conventional TWT described above, embodiments of the present invention employ a radioactive isotope providing charged particles rather than an electron gun providing electrons. A typical embodiment of the invention includes a radioactive isotope producing charged particles and a slow-wave structure receiving a low power signal input. The slow-wave structure receives at least some of the charged particles and the received charged particles interact with the low power signal input to generate a high power signal output, the high power signal output corresponding to the low power signal input. The charged particles, e.g. alpha particles from ²³⁸Pu, are formed into a beam which is passed through the slow-wave structure. The particle beam is employed to mediate the electromagnetic interaction with RF wave instead of an electron beam.

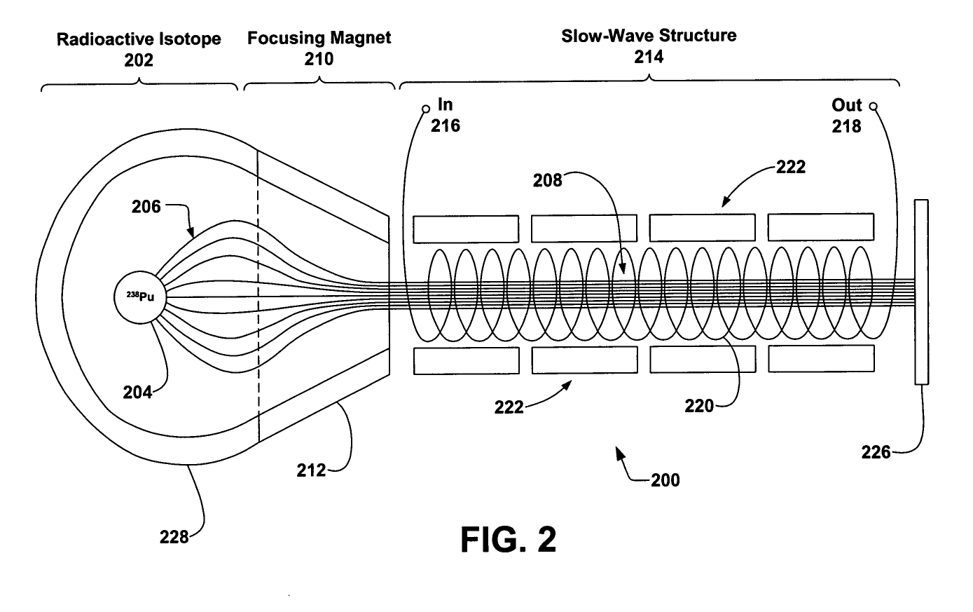

FIG. 2 illustrates an exemplary traveling wave tube 200 using a radioactive isotope 202 as a charged particle source. The traveling wave tube 200 employs a plutonium isotope 204 (²³⁸Pu) which emits alpha particles 206. Each emitted alpha particle 206 has a charge approximately twice that of an electron 106 emitted by the electron gun 102 of a conventional traveling wave tube 100. It is important to note that embodiments of the invention may also use other radioactive isotopes and corresponding emitted charge particles. The principle of operation is unchanged as understood by those skilled in the art. For example, embodiments of the invention may employ alpha particles may be emitted by other radioactive isotopes such as ²¹⁰Po, 242 Cm and ²⁴⁴ Cm. In addition, embodiments of the invention may employ beta particles (substantially identical to electrons in charge and mass) emitted from radioactive isotopes such as ⁹⁰Sr, ¹⁰⁶Ru, ¹⁴⁴ Pm, ¹⁷⁰Tm, ¹³⁷Cs and ¹⁴⁴Ce.

One important consideration in employing a radioactive isotope 202 determining how to form the emitted particles 206 into a proper particle beam 208 for the slow-wave structure 214. The radioactive isotope 202 emits particles 206 in all directions. A portion of the emitted particles 206 must be redirected to form a particle beam 208. This can be accomplished with a focusing magnet 210.

The focusing magnet 210 draws in a portion of the particles 206 emitted from the radioactive isotope 202 and influences them in order to produce a beam 208 of particles 206 concentrated and moving in collinear paths at the exit of the focusing magnet 210. The magnet 210 is disposed between the radioactive isotope 202 and the slow-wave structure 214. The magnet 210 focuses the charged particles 206 into a beam 208 which is passed through the slow-wave structure 214. The magnet 210 may comprise a permanent magnet and/or a plurality of magnet segments. In one exemplary embodiment, focusing magnet 210 is substantially conical permanent magnet 212 with an axial passage for the charged particles 206 to pass through. In alternate embodiments, the focusing magnet 210 can be electromagnetic or any other form capable of influencing the charged particles 206.

The formed beam 208 of charged particles 206 is directed into the slow-wave structure 214. The slow-wave structure 214 employed in the traveling wave tube 200 using a radioactive isotope 202 is substantially identical to the slow-wave structure 114 employed in a conventional traveling wave tube 100. The charge particles 206 are maintained in a beam 208 by one or more permanent magnets 222 surrounding the flow as it passes through the slow-wave structure 214. The low power signal input 216 and the high power signal output 218 are each coupled to the received charged particles 206 through at least one helical conductor 220. Each helical conductor 220 comprises a plurality of coils. The received charged particles 206 pass through the axis of the helical conductor 220. As the low power RF signal is carried by the helical conductor 220, a corresponding electric field is produced around the coiled wire which interacts with the beam 208 of charged particles 206 passing through the center of the slow-wave structure 214. The conductors 220 receive the low power RF signal at the input 216 and deliver a high power RF signal at the output 218 (e.g. through directional couplers). The helical conductor 220 may be disposed such that the low power signal input 216 is upstream of the charged particle 206 flow from the high power signal output 218.

The interaction between the beam 208 and the RF signal results in energy being transferred from the charged particles 206 of the beam 208 to the low power RF signal. Thus, the low power RF signal is amplified to a high power RF signal at the output 218. Many electrical configurations are possible. For example, the input 216 and output 218 share a common electrical ground at some intermediate position of the helical conductor 220 similar to the conventional TWT 100 of FIG. 1. The coils of the helical conductors 220 serve the important purpose of effectively “slowing” the speed of the RF signal it carries relative to the electron beam along the axis of the slow-wave structure 214. The RF signal moves along the length of the electrical conductor at an unchanged speed (approximately the speed of light), however, its speed is reduced along the axis of the slow-wave structure 214 because it must pass around each coil. Accordingly, the relative speed between the RF signal and the charged particle 206 beam 208 can be varied with the number of coils and/or diameter of the coils of the helical conductors 220.

Because the traveling wave tube 200 employs a radioactive isotope 202, it is advisable in many applications to employ proper shielding. Accordingly, the spent charged particles 206 which leave the slow-wave structure 214 may be absorbed by a shield 226. Similarly, a shielded chamber 228 can be used to cover the exposed areas of the radioactive isotope 202 which emit particles 206 that are not directed into the beam 208. Additional shielding may be added as necessary for safe handling and proper operation of the traveling wave tube 200. Charged particles 206 which impact shielding may cause an electro-chemical interaction producing gas. The liberated gas is mainly He, because alpha particles are essentially a He nucleus. The gas may be vented or removed using some type of ion pump.

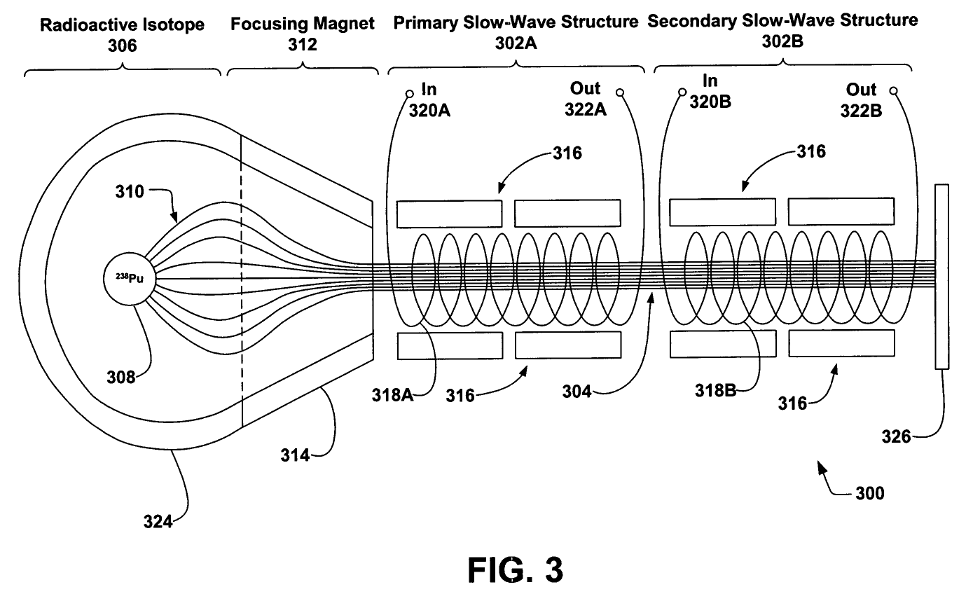

FIG. 3 illustrates a series of slow-wave structures implemented with a single radioactive particle source. In this TWT 300 at least two slow-wave structures 302A, 302B are connected in series operating on a common particle beam 304. The radioactive isotope 306 (e.g. plutonium isotope 308, ²³⁸Pu) emits charge particles 310 which are focused into the particle beam 304 by the focusing magnet 312. The focusing magnet 312 may comprise substantially conical permanent magnet 314 or any other acceptable alternate.

For each slow-wave structure 302A, 302B, one or more permanent magnets 316 are used to maintain the particle beam 304. Operation of each slow-wave structure 302A, 302B is essentially the same as the slow-wave structure 214 of FIG. 2. Each slow-wave structure 302A, 302B includes at least one helical conductor 318A, 318B which each have an input 320A, 320B and output 322A, 322B for receiving a low power signal and delivering the amplified signal, respectively. In this TWT 300, the secondary slow-wave structure 302B may be fed with a substantially low frequency signal rather than an RF signal. The charged particles 310 in the beam 304 are slowed down further in the secondary slow-wave structure 302B and extracted energy is converted to substantially DC power.

As before, the spent charged particles 310 which leave the slow-wave structures 302A, 302B may be absorbed by a shield 326. Similarly, a shielded chamber 324 may be employed to cover the exposed areas of the radioactive isotope 306 which emit particles 310 that are not directed into the beam 304. Additional shielding may be added as necessary for safe handling and proper operation of the traveling wave tube 300.

Due to the hazardous nature of the radioactive isotope, in a further embodiment of the invention, a plurality of slow-wave structures may be employed with a single radioactive particle source. This eliminates the use of separate particle sources and maximizes the energy extracted from a single source. The use of multiple slow-wave structures optimizes the geometrical acceptance into the slow-wave structure in order to improve overall efficiency.

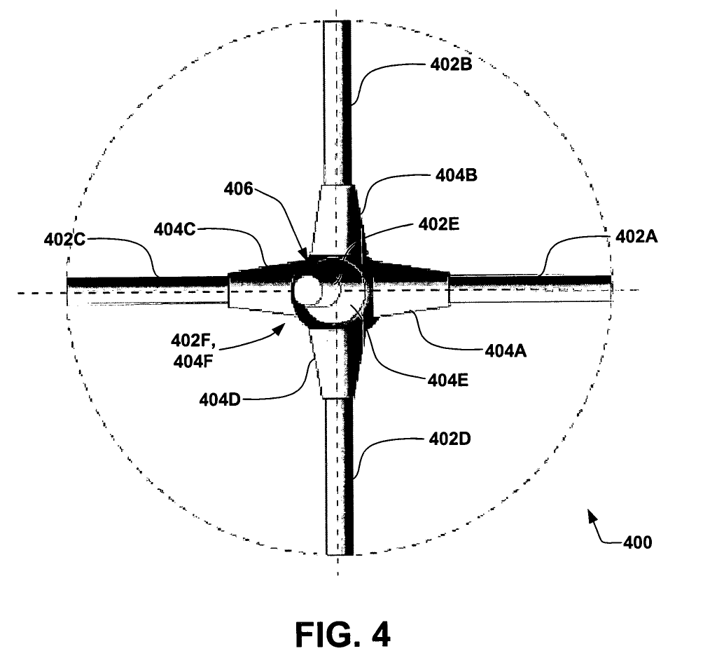

FIG. 4 illustrates a traveling wave tube system 400 employing multiple slow-wave structures 402A-402F operating in parallel. (Slow-wave structure 402F is out of view, opposite slow-wave structure 402E behind the radioactive isotope 406.) The system 400 is implemented with a single radioactive isotope 406 particle source at the center. Each receives a portion of the charged particles from the radioactive isotope 406. Each of the slow-wave structures 402A-402F operates in the same manner that of the traveling wave tube 200 described in FIG. 2. Furthermore, any one of the slow-wave structures 402A-402F can alternately comprise multiple series connected slow-wave structures, e.g. as describe in FIG. 3.

However in the system 400, respective portions of charged particles are directed through focusing magnets 404A-404F to form particle beams for each of the slow-wave structures 402A-402F. The received portion charged particles of each of the plurality of slow-wave structures 402A-402F interacts with a distinct low power signal input to generate a distinct high power signal output for each of the independent slow-wave structures 402A-402F. The plurality of slow-wave structures 402A-402F are disposed radially around the radioactive particle source, extending away from the radioactive isotope 406. In one exemplary embodiment shown in FIG. 4, the plurality of slow-wave structures 402A-402F comprises three pairs of slow-wave structures 402A and 402C, 402B and 402D, 402E and 402F and each pair is substantially collinear on opposite sides of the radioactive isotope 406 and the pairs are orthogonally arranged.

Of course, other configurations using different numbers of slow-wave structures 402 and focusing magnets 404 are also possible. In general, the slow-wave structures 402 are arranged in a radial and symmetric pattern around the radioactive isotope 406. The example of FIG. 4 may be referenced as a hexahedron pattern because the combination of normal surfaces for each slow-wave structure 402A-402F forms a hexahedron or cube. Similarly, some other embodiments may include patterns defined by tetrahedron, octahedron, dodecahedron, icosahedron or any other polyhedron.

There are some characteristics to consider in developing a specific TWT using a radioactive isotope charged particle source. For example, if alpha particles are used, the magnetic field strength used to manipulate the alpha particles must be approximately four times the magnetic field strength used to manipulate electrons because alpha particles possess approximately twice the charge of electrons. Thus, magnets used to focus and maintain an alpha particle beam, e.g. magnet 210 and magnets 222 must be approximately four times as strong as those used to manipulate an electron beam. Of course, embodiments of the invention employing beta particles with the same charge as electrons do not exhibit this difference. However, at least some aspects of the helical conductor design, e.g. the number of coils per unit length, may remain substantially similar because emitted alpha particles (emitted from ²³⁸Pu with approximately 5 MeV kinetic energy) have approximately the same velocity as electrons accelerated in a conventional TWT electron gun.

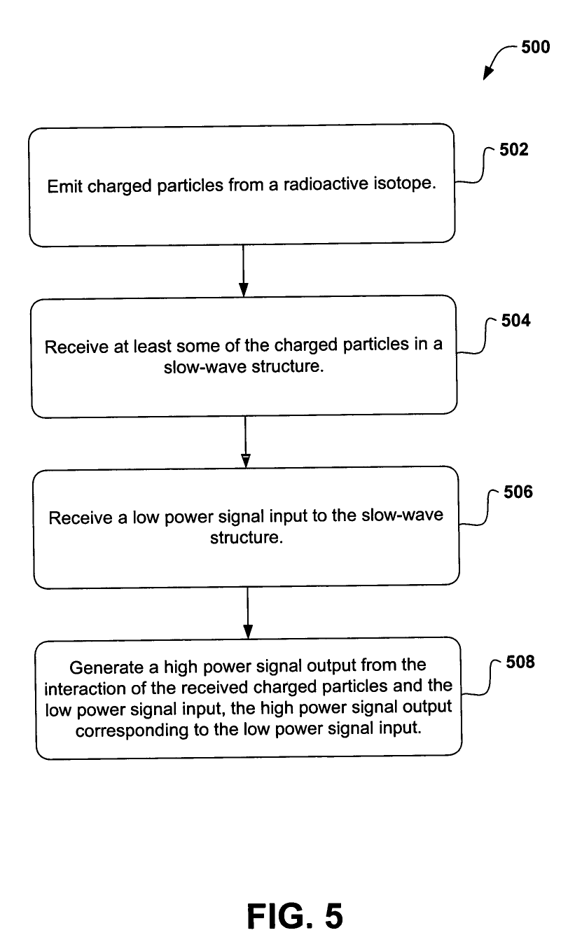

FIG. 5 is a flowchart of an exemplary method 500 of amplifying an RF wave employing a radioactive isotope as a charged particle source. At step 502, charged particles are emitted from a radioactive isotope. At step 504, at least some of the charged particles are received in a slow-wave structure. At step 506, a low power signal input is received by the slow-wave structure. Finally at step 508, a high power signal output is generated from the interaction of the received charged particles and the low power signal input. The high power signal output corresponds to the low power signal input. In further embodiments, the method 300 may be modified consistent with the apparatus embodiments previously described.

3. Analysis of Alpha Traveling Wave Tube and Particle Source

The characteristics of an exemplary traveling wave tube using alpha particles from a radioactive isotope may be analyzed using a 1-dimensional TWT simulation code. For example CHRISTINE, developed by T. M. Antonsen Jr, B. Levush, D. Chernin and P. N. Safier at the Naval Research Lab and University of Maryland, solves the Lorentz force equation and Maxwell's equation numerically with an assumed 1-dimensional structure. Interactive Beam Code (IBC), developed by Ian Morey and Charles Birdsall at the University of California, Berkeley, solves physical equations numerically employing a particle-in-cell (PIC) approach on the discrete space-time lattice. See “CHRISTINE: A Multifrequency Parametric Simulation Code for Traveling Wave Tube Amplifiers”, NRL Report 97-9845, 1997 and “Travelling Wave Tube Simulation: IBC code”, Ian J. Morey, C. K. Birdsall, IEEE Transactions on Plasma Science, Vol. 18, No. 3, June 1990, which are both incorporated by reference herein.

For this example, a conventional electron TWT (e.g. as shown in FIG. 1) with the beam current 70 mA and the cathode voltage of 3 kV is compared to the alpha TWT with the 10 moles of ²³⁸Pu source (e.g. as shown in FIG. 2) with 88% geometrical acceptance at 10 GHz. (Geometrical acceptance is describe ed hereafter.) In both cases, the mathematical parameters for slow-wave structure (helix pitch, helix radius etc.) are optimized to obtain the highest efficiency. A conventional TWT has approximately 60 dB small signal gain with peak output power 145 W. It has approximately

$$\frac{145 W}{0.07 A \times 3000 V} = 69.1 \% \qquad ( 1 )$$

of RF conversion efficiency. This definition of efficiency is somewhat different from the conventional definition of efficiency, since it omits the spent beam collection at the collector. If one includes this factor, overall efficiency will be much higher. An exemplary alpha TWT is shown to have a smaller signal gain of about 40 dB with 130 W peak output power. It has approximately

$$\frac{130 W}{138 W \times 10 \times 0.88 \times \frac{1}{6}} = 64.2 \% \qquad ( 2 )$$

of RF conversion efficiency where a mole of ²³⁸Pu source emits particles at a rate of 138 W and 6 TWTs are attached to cover all solid angles (e.g. as shown in the embodiment of FIG. 4). Note that the Alpha TWT has a notably low phase shift (about 25 degrees) compared to a conventional TWT (about 40 degrees).

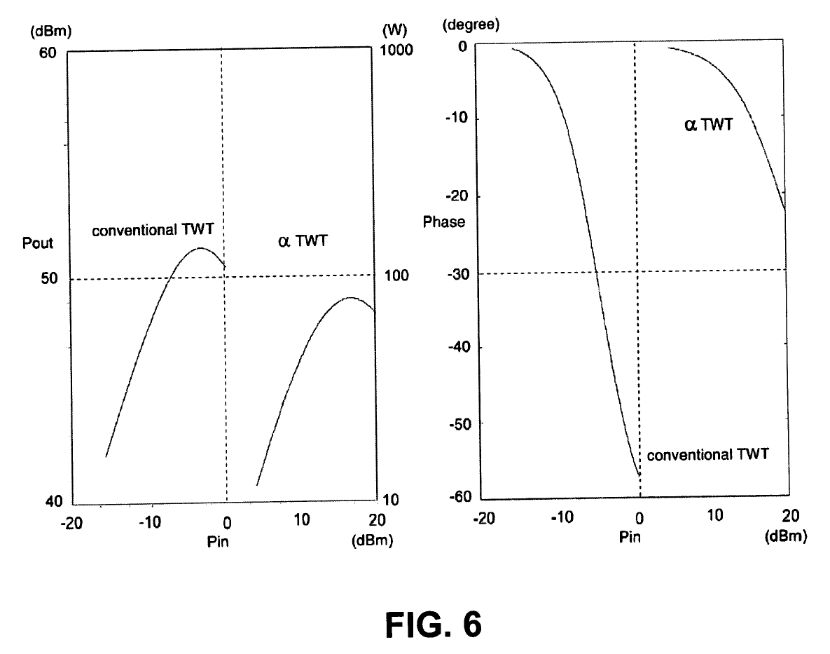

FIG. 6 shows theoretical plots of a illustrating a estimated performance comparison between a conventional traveling wave tube and an alpha traveling wave tube.

For the exemplary particle source, the decay probability per sec (i.e., the quantum mechanical probability of penetrating the nuclear binding potential) is given as

$$P = - \frac{1}{N} \frac{ⅆ N}{ⅆ t} \qquad ( 3 )$$

which leads to
N(t)=λe^{-pt} (4)
Equation (3) can be rewritten as

$$- \frac{ⅆ N}{ⅆ t} = N P = N \frac{0.693}{{T}_{1 / 2}} \qquad ( 5 )$$

whereas half life T_{1/2} is given as
0.5=e^{-PT}^{_{1/2}} (6)
For example, ²³⁸Pu has a half-life of 87 years, and 1 mole (=238 g) of ²³⁸Pu will radiate alpha particles (100% branching ratio) at the approximate rate of

$$- \frac{ⅆ N}{ⅆ t} = 6 \times {10}^{23} \frac{0.693}{87 \times 365 \times 24 \times 60 \times 60 sec} \\ = 6 \times {10}^{23} \frac{0.693}{1.7436 \times {10}^{9} sec} \approx 1.515 \times {10}^{14} \text{/} sec \qquad ( 7 )$$

which is approximately equivalent to
2×1.515×10¹⁴×1.6×10⁻¹⁹ C/sec=48.5 μA (8)
This is approximately equivalent to
1.515×10¹⁴×1.6×10⁻¹⁹ C×5.7×10⁶ V/sec=138.2 W (9)
for the total solid angles.

A configuration as illustrated in FIG. 4 will cover approximately 88% of fractional solid angle, i.e.,

$$\frac{{Ω}^{′}}{Ω} = \frac{2 π {R}^{2} {\int }_{0}^{π / 4} sin θ ⅆ θ}{4 π {R}^{2}} \times 6 = \frac{3 ( 2 - \sqrt{2} )}{2} = 0.8787 \qquad ( 10 )$$

If all captured alpha particles by the solid angle are focused and fed into the TWT properly, it will lose about 12% of the energy through thermal energy before entering TWT by hitting the area which is not covered by the solid angles.

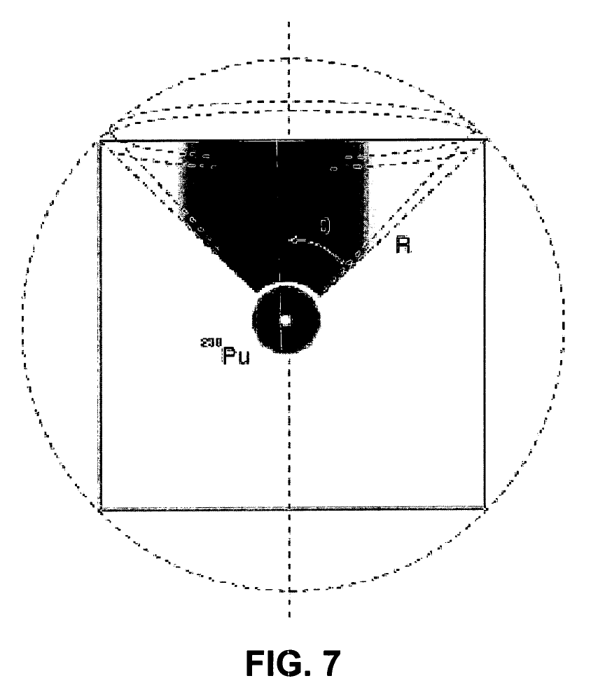

FIG. 7 illustrates capturing alpha particles emitted from the ²³⁸Pu source as defined in Equation (10). The solid angles define the portion of total surface area of a spherical surface surrounding the ²³⁸Pu source that is covered by the focusing magnets 404A-404F of FIG. 4. The ²³⁸Pu source is assume to be spherical. Alternate source and focusing magnet shapes, as can be developed by those skilled in the art, may yield different results.

In an exemplary embodiment configured as the TWT 300 of FIG. 3, after interacting with RF wave, alpha particles still have about 50-60% of their kinetic energy. By including the secondary slow-wave structure which is fed with the low frequency signal, alpha particles can be slowed down further and extracted energy is converted to DC (about 90% at 100 kHz) power. So, overall energy loss due to the heat is estimated to be
(0.12+(1−0.12)×0.5×0.5)−138.2 W/mole=46.98 W/mole (11)
which is about 34% of the total energy. In other words, this configuration is estimated to be 66% efficient.

Detailed simulations can be performed to calculate RF signal characteristics such as gain, transfer (AM/AM, AM/PM) and efficiency using simulation code such as PIC (particle-in-a-cell) as is known in the art.

4. Exemplary Radioactive Isotope Traveling Wave Tube Applications

TWTs are widely used in communication satellites and radar systems as the high power amplifier (HPA) to transmit the data. The exemplary alpha TWT described above can drastically reduce the weight and cost of the satellite by substantially reducing the need for solar arrays and batteries as the HPA on a typical payload consume roughly 90% of the available power. A similar concept can be applied to increase the efficiency of Radioisotope Thermoelectric Generators (RTG) to more than 50% where the conventional thermoelectric efficiency is under 10% without any moving parts. Two significant applications for TWT embodiments of the invention are communications satellites and a radioisotope electric generator.

TWT embodiments of the invention in communication satellites can drastically reduce or eliminate the need for a large, massive solar arrays and batteries. For example, in a typical spacecraft, the solar array and battery supply may approximately 90% of the total power to the high voltage system of TWT. Typically, the combined systems weigh anywhere between 0.5 to 1 ton and cost more than $15 million. In terms of unit wattage, the conventional solar array, battery and electrical power conditioner (EPC) cost and weigh approximately $1500/W and 55 g/W, respectively. In contrast a comparable alpha TWT embodiment of the present invention may cost approximately $600/W and weigh approximately 3 g/W. This is a phenomenal saving in terms of both satellite manufacturing cost and weight. In addition to these advantages, because alpha particles have a much greater mass than electrons, the TWT amplifiers of the present invention have less phase distortion (linear) than conventional TWTs.

TWT embodiments of the present invention may also be applied in a radioisotope TWT electric generator (RTEG). A conventional radioisotope thermoelectric generator (RTG) employs a thermoelectric coupling device to convert heat into electricity with typical conversion efficiencies under 10%. The slow-wave device like a TWT embodiment of the present invention can extract AC power as high as 60% of the total beam power. Considering the efficiency of 90% or higher for an AC-DC conversion efficiency at around 500 kHz, more than 50% overall efficiency of converting the total kinetic energy to DC power is achievable.

This concludes the description including the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the foregoing teaching.

What is claimed is:

1. An apparatus, comprising:
a radioactive isotope producing charged particles; and
a slow-wave structure receiving a low power signal input;
wherein the slow-wave structure receives at least some of the charged particles and the received charged particles interact with the low power signal input to generate a high power signal output, the high power signal output corresponding to the low power signal input.

2. The apparatus of claim 1, wherein the slow-wave structure is one of a plurality of slow-wave structures, each receiving a portion of the charged particles.

3. The apparatus of claim 2, wherein the plurality of slow-wave structures are disposed radially around the radioactive isotope operating in parallel.

4. The apparatus of claim 2, wherein the plurality of slow-wave structures comprises three pairs of slow-wave structures;
wherein each pair is substantially collinear on opposite sides of the radioactive isotope and the pairs are orthogonally arranged.

5. The apparatus of claim 2, wherein the received portion charged particles of each of the plurality of slow-wave structures interacts with a distinct low power signal input to generate a distinct high power signal output.

6. The apparatus of claim 2, wherein at least two of the plurality of slow-wave structures are connected in series operating on a common particle beam.

7. The apparatus of claim 6, wherein at least one of the plurality of slow-wave structures connected in series operating on the common particle beam produces substantially DC power.

8. The apparatus of claim 1, further comprising a magnet disposed between the radioactive isotope and the slow-wave structure, the magnet focusing the charged particles into a beam passing through the slow-wave structure.

9. The apparatus of claim 8, wherein the magnet comprises a permanent magnet.

10. The apparatus of claim 8, wherein the magnet is substantially conical with an axial passage for at least some of the charged particles.

11. The apparatus of claim 1, wherein the charged particles comprise alpha particles and the radioactive isotope is selected from the group consisting of ²³⁸Pu, ²¹⁰Po, ²⁴²Cm, and ²⁴⁴Cm.

12. The apparatus of claim 1, wherein the charged particles comprise beta particles and the radioactive isotope is selected from the group consisting of ⁹⁰Sr, ¹⁰⁶Ru, ¹⁴⁴ Pm, ¹⁷⁰Tm, ¹³⁷Cs, and ¹⁴⁴Ce.

13. The apparatus of claim 1, wherein the low power signal input and the high power signal output are each coupled to the received charged particles through helical conductors, the received charged particles passing through the helical conductors.

14. The apparatus of claim 13, wherein the helical conductors are disposed such that the low power signal input is upstream of a flow of the charged particles relative to the high power signal output.

15. A method, comprising the steps of:
emit charged particles from a radioactive isotope;
receiving at least some of the charged particles in a slow-wave structure;
receiving a low power signal input to the slow-wave structure; and
generating a high power signal output from the interaction of the received charged particles and the low power signal input, the high power signal output corresponding to the low power signal input.

16. The method of claim 15, wherein the slow-wave structure is one of a plurality of slow-wave structures, each receiving a portion of the charged particles.

17. The method of claim 16, wherein the plurality of slow-wave structures are disposed radially around the radioactive isotope.

18. The method of claim 16, wherein the plurality of slow-wave structures comprises three pairs of slow-wave structures;
wherein each pair is substantially collinear on opposite sides of the radioactive isotope and the pairs are orthogonally arranged.

19. The method of claim 16, wherein the received portion charged particles of each of the plurality of slow-wave structures interacts with a distinct low power signal input to generate a distinct high power signal output.

20. The method of claim 16, wherein at least two of the plurality of slow-wave structures are connected in series.

21. The method of claim 20, wherein at least one of the plurality of slow-wave structures connected in series operating on the common particle beam produces substantially DC power.

22. The method of claim 15, further comprising a magnet disposed between the radioactive isotope and the slow-wave structure, the magnet focusing the charged particles into a beam passing through the slow-wave structure.

23. The method of claim 22, wherein the magnet comprises a permanent magnet.

24. The method of claim 22, wherein the magnet is substantially conical with an axial passage for at least some of the charged particles.

25. The method of claim 15, wherein the charged particles comprise alpha particles and the radioactive isotope is selected from the group consisting of ²³⁸Pu, ²¹⁰Po, ²⁴² Cm, and ²⁴⁴ cm.

26. The method of claim 15, wherein the charged particles comprise beta particles and the radioactive isotope is selected from the group consisting of ⁹⁰Sr, ¹⁰⁶Ru, ⁴⁴ Pm, ¹⁷⁰Tm, ¹³⁷Cs, and ¹⁴⁴Ce.

27. The method of claim 15, wherein the low power signal input and the high power signal output are each coupled to the received charged particles through helical conductors, the received charged particles passing through the helical conductors.

28. The method of claim 27, wherein the helical conductors are disposed such that the low power signal input is upstream of a flow of the charged particles relative to the high power signal output.

29. An apparatus, comprising:
a radioactive isotope means for producing charged particles; and
a slow-wave structure means for receiving a low power signal input;
wherein the slow-wave structure receives at least some of the charged particles and the received charged particles interact with the low power signal input to generate a high power signal output, the high power signal output corresponding to the low power signal input.
